(19) United States
(12) Patent Application Publication
(10) Pub. No.: US 2006/0162985 A1
(43) Pub. Date: Jul. 27, 2006

(54) System for crash prediction and avoidance

(75) Inventors: Yoshihiko Tanaka, Hikone-shi (JP); Eiji Yanagi, Hikone-shi (JP)

Correspondence Address: FOLEY AND LARDNER LLP;SUITE 500, 3000 K STREET NW, WASHINGTON, DC, 20007, US

(73) Assignee: TAKATA CORPORATION

(21) Appl. No.: 11/335,526

(22) Filed: Jan. 20, 2006

Related U.S. Application Data
(60) Provisional application No. 60/646,621, filed on Jan. 26, 2005.

(51) Int. Cl. B60T 7/16; B60K 28/10; G08G 1/16

(52) U.S. Cl. 180/279; 180/167; 180/275; 701/301; 340/436

(57) ABSTRACT

A system for predicting and avoiding crashes is disclosed. The system includes one or more sensors for sensing various obstructions, a controller for processing the signals from the sensors to determined whether a collision is predicted, and a monitor and/or an alarm for alerting the driver of any obstructions. The system may also include a transmitter/receiver for receiving information from other vehicles and using that information to either determining whether a crash is predicted or for displaying obstructions which have been identified by the other vehicles.

### CROSS-REFERENCE TO RELATED PATENT APPLICATIONS

This application claims priority to and the benefit of U.S. Provisional Patent Application Serial No. 60/646,621, filed on Jan. 26, 2005, which is incorporated herein by reference in its entirety.

### BACKGROUND OF THE INVENTION

The present application relates to a process and system for predicting vehicle crashes and avoiding these crashes. The process and system also predict crashes for vehicles following a first vehicle and allows vehicles following the first vehicle to prevent chain crashes.

While driving a car, a driver senses various conditions through the objects in his view and, as a case may be, he must take an action to avoid any possible crash or collision. In an emergency, however, drivers will often become panicked and, as a result, may not properly handle the vehicle. Even if the driver is not panicked, it may be impossible to avoid the crash because of a delay in responding to the stimuli indicating a crash is imminent. Various techniques have been developed to avoid collisions, such as a crash predicting device connected to an image pick-up device mounted on the vehicle, as disclosed in U.S. Pat. No. 5,541,590 to Nishio. The crash predicting device in Nishio includes a neural network which is previously trained with training data to predict the possibility of a crash based on ever changing views from the image pick-up device.

Systems, such as Nishio, rely on information based on sensors mounted on the vehicle itself. However, much accurate results can be obtained from data not only from the automobile's own sensors but from data obtained from other vehicles in traffic.

Further, the sooner that the driver becomes aware of the danger, the less likely a collision will occur. If a possible obstruction is relayed to the driver, he or she can take a suitable course of action before the collision occurs. Thus, there is a need to have a monitor which informs the driver of any possible obstructions near the vehicle.

Even if a collision or crash is predicted, a driver might not be able to respond adequately to the emergency because of a panicked state of mind or because the driver is not given enough time to response. Thus, there is a need to have a controller that receives information that a collision or crash is possible and takes suitable precautions, such as employing the brakes, controlling the engine, or engaging a safety device like an airbag.

### SUMMARY

According to an embodiment of the present invention, a process for predicting and avoiding vehicle crashes is provided. To predict crashes, information regarding the position of the vehicle and possible obstructions for the vehicle is collected. Possible vehicle obstructions include other vehicles, people, or objects in the path of the vehicle that may create the possibility of a crash for the vehicle. Vehicles may include automobiles, trucks, buses, and other passenger transportation known in the art.

Information regarding the position of possible obstructions may be used to predict crashes. The driver of a vehicle may be alerted of possible obstructions through a navigation system within the vehicle, increasing the probability of crash avoidance. The navigation system may include a monitor for displaying obstructions. The navigation system may also include a map that displays the location of the vehicle and possible obstructions on the map.

Sensors in the vehicle may be used to collect and update information regarding obstructions in the path of the vehicle. Crash prediction sensors may be used to detect obstructions in the path of the vehicle and to provide information on the positions of the obstructions. Side sensors may be used to detect obstructions transverse to the vehicle, such as other vehicles moving towards the vehicle with the crash prediction system. Sensors may include cameras, radar, and other sensors known in the art for detecting objects and their positions. Sensors may be used in combination to improve the accuracy of crash predictions. For example, crash prediction sensors may be used in combination with side sensors for this purpose.

Information regarding obstructions may also be used to activate alarms to warn a driver of predicted crashes, depending upon the nature or severity of a predicted crash. Alarms may include warning lights, speakers, warning sounds, and other warning devices known in the art. For example, a light may be used to warn a driver of a possible crash with another vehicle traveling transversely to the driver's vehicle. Such alarms may be used in combination with the monitor and/or map of the navigation system in a vehicle.

In a further embodiment, crash prediction information may be used to avoid or minimize crashes by automatically controlling engine devices and systems, braking devices and systems, and passenger safety devices and systems. For example, crash prediction information may be used to reduce the speed of an engine, to activate or increase braking, and to activate seat belt systems (including e.g., motorized seat belt retractors (MSB)), airbags and/or other safety systems. A controller may be used to collect information from sensors, to activate alarms, control the navigation system, and to automatically control engine, braking, and safety devices or systems. A controller may include an electronic control unit (ECU) computer, microprocessor, and other control devices known in the art.

In a further embodiment of the present invention, the crash prediction system transmits crash prediction information from a first vehicle to other vehicles by a transmission device. For example, crash prediction information may be transmitted to a vehicle following the first vehicle. This allows a crash prediction system in other vehicles to use information from the first vehicle to predict possible crashes involving the other vehicles, including chain crashes. Transmission may be performed via radio transmitters or other transmission devices known in the art.

Information transmitted from a first vehicle to other vehicles includes obstructions detected by the first vehicle and status information regarding the first vehicle. Status information may include steering information, braking information, passenger safety device or system status, and anti-lock braking system (ABS) status. For example, steering information may indicate abrupt steering that may be due an obstruction or the braking may cause a crash itself. Braking information may indicate harsh braking. Safety device/system status may indicate the deployment of airbags, the activation of seat belt retractors, or the use of other passenger safety devices and systems known in the art. ABS system status may indicate the presence of slippery road conditions or that the first vehicle is slipping. Therefore, the crash prediction information transmitted to other vehicles is used to not only predict crashes due to obstructions in the path of a first vehicle and subsequent vehicles, but to also predict crashes due to actions of the first vehicle and/or driver of the first vehicle.

The navigation system monitors in other vehicles may also display obstructions in front of a first vehicle by using information transmitted from the first vehicle. Navigation system maps may show the position of obstructions, the first vehicle, and other vehicles in the vicinity. Crash prediction systems in other vehicles may also include sensors and warning devices for the driver, as explained above.

In a further embodiment, crash prediction information transmitted from a first vehicle may be used to avoid or minimize crashes by automatically activating engine, braking, and passenger safety systems in other vehicles, as explained above.

It is to be understood that both the foregoing general description and the following detailed description are exemplary and exemplary only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a schematic view of an embodiment of the crash prediction and avoidance system of the present invention.

FIG. 2 is a plan of a radar sensor mounted on the vehicle for use in the crash prediction and avoidance system of the present invention.

FIG. 3 shows a front view of the monitor used in the crash prediction and avoidance system.

FIG. 4 is a schematic view of an embodiment of the crash prediction and avoidance system wherein information is transmitted from one vehicle to another.

FIG. 5 is a plan view of two vehicle on a road, which utilizes the crash prediction and avoidance system of the present invention.

### DETAILED DESCRIPTION

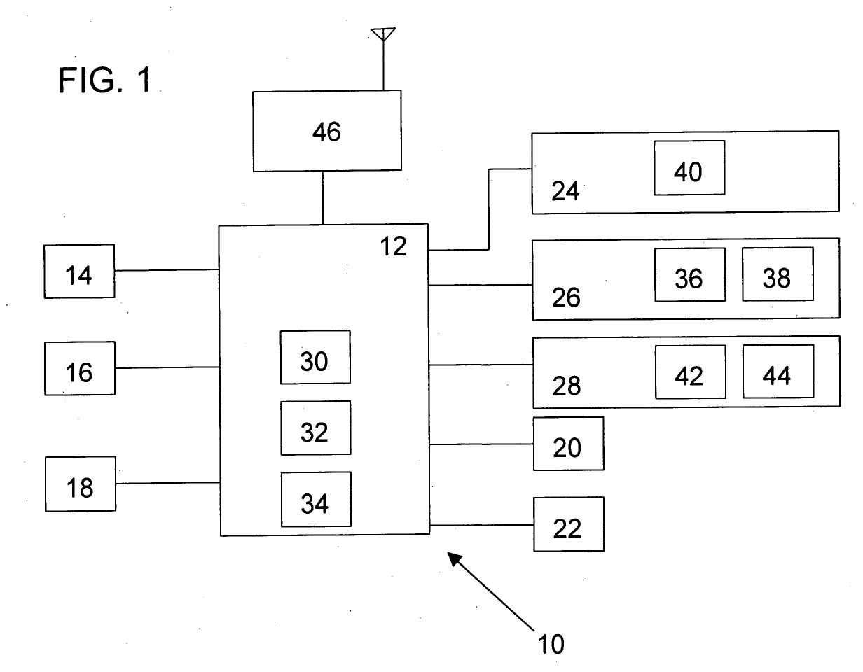

FIG. 1 illustrates a crash prediction and avoidance system in a vehicle. The system includes a navigation system 10 that includes a controller 12. The controller collects signals from one or more sensors 14, 16, 18 that are placed in the vehicle. The controller may perform a variety of functions, such as monitoring the location of possible obstructions and predicting the possibility of collisions. The controller then can output the results of its calculations in a variety of ways. For example, the controller 12 can provide the location of an obstruction to the driver or passenger through a monitor 20. Alternatively or in addition to the monitor, the controller may activate a warning to driver or passenger through the use of an alarm 22 if a collision is predicted. Also, the controller may activate one or more systems in an attempt to avert the predicted collision or lessen the potential injury to the vehicle's occupants. For example, the controller 12 may activate the vehicle's braking system 24, the engine system 26, and/or one or more safety devices 28.

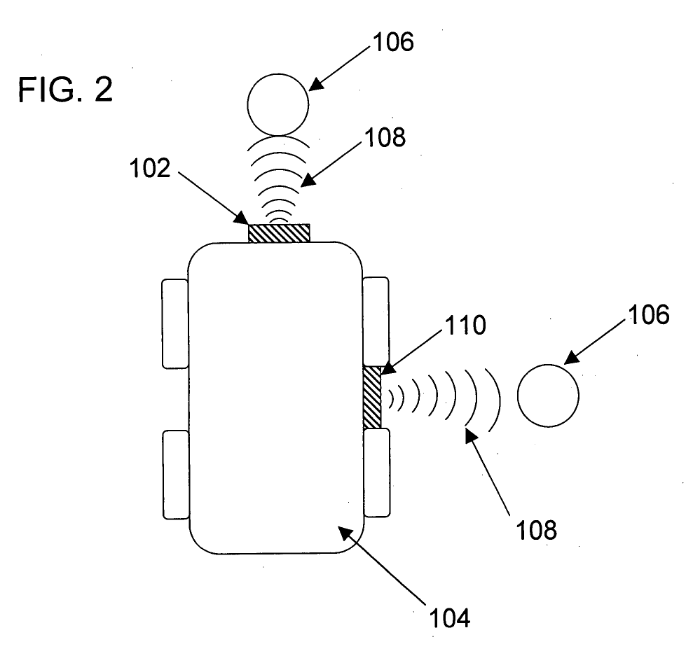

In relation to the sensors 14, 16, 18, various types of sensors can be used. For example, such sensors include the use of radar, infrared systems, lasers, ultrasonic systems, cameras, or other sensors known in the art. In the example of a radar system, as shown in FIG. 2, a radar sensor 102 is mounted on the front end of a vehicle 104. A pulse 108 is emitted from the radar sensor 102 and makes contact with an obstruction 106. The obstruction 106 can be anything in the vehicle's path such as a person, another vehicle, or a tree lying in the street. The pulse is reflected back to the radar sensor 102.

Once the reflected pulse is detected by the sensor 102, the signals from the sensor are transmitted to the controller 12 to calculate the distance between the vehicle 102 and obstruction 106 based on the pulse's travel time. A tracking algorithm may be employed to track the obstruction's position relative to the vehicle 104 by storing the obstruction's location at a plurality of successive time intervals. By tracking the obstruction's position, the vehicle's velocity and acceleration relative to the obstruction are calculated based on the distance between the vehicle and the obstruction at various times. A probable collision can be detected by calculating the vehicle's position, velocity, and acceleration relative to the obstruction and comparing these values to predetermined thresholds. If the values satisfy these thresholds, a collision will be predicted by the controller 12.

The sensors may be mounted anywhere on the vehicle including sensors mounted on the side of the vehicle 104 to detect any obstructions transverse to the vehicle, such as the sensor 110 depicted in FIG. 2. Although only one sensor may be used, a combination of the same type of sensors or a combination of different types of sensors may be used so as to improve the accuracy of the crash predictions.

The controller may comprise several components, such as a microprocessor 30, a memory 32, and/or an electronic control unit 34 (ECU), which are operatively connected to each other. The microprocessor 30 receives the signals from the one or more sensors 14, 16, 18 and performs calculations to ascertain the location of the obstructions as well as the likelihood of a crash. These calculations may involve processing the signals from the various sensors to ascertain the location, velocity, and acceleration of the vehicle relative to the various obstructions. The location of these obstructions may be displayed to the monitor 20.

The calculated location, velocity, and acceleration values from the various sensors are evaluated against a computer model to determine if a crash is predicted. The computer model can be generated by a variety of methods known in the art. One example is to compare the calculated values to predetermined thresholds and if a certain number of thresholds are satisfied, a crash is predicted. Another example is using a neural network, as disclosed in U.S. Pat. Nos. 5,377,108 and 5,541,590, herein incorporated by reference. The computer model and the algorithms for carrying out the necessary calculations are stored in the memory 32. The memory 32 may comprise a ROM, a RAM, an EEPROM and/or any known memory device.

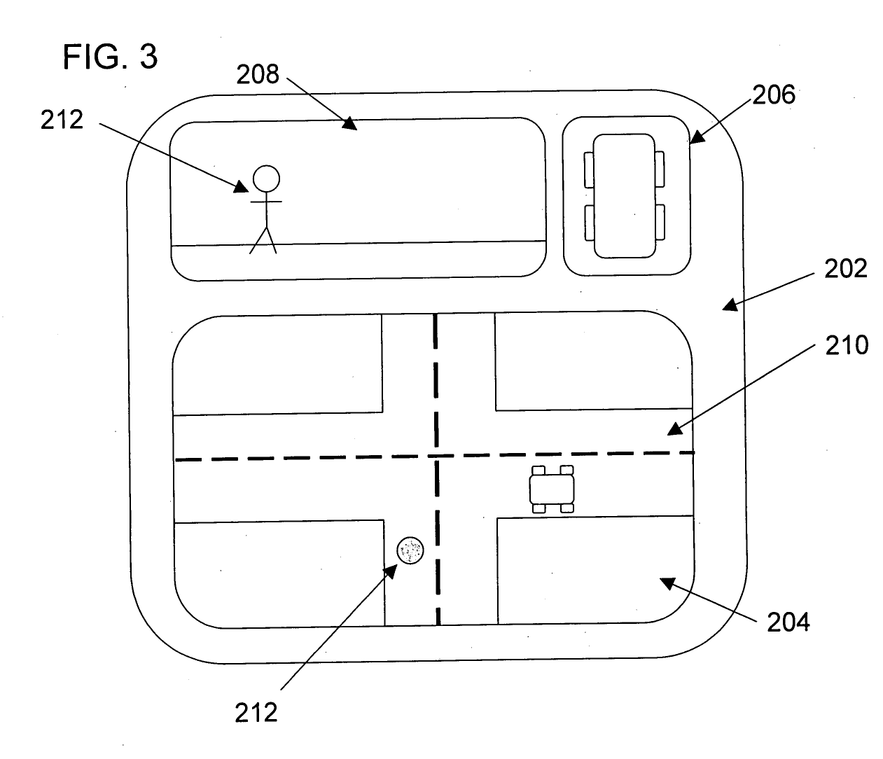

After the controller determines the location of an obstruction, this information is outputted to a monitor 202 for the driver's consideration, as shown in FIG. 3. The monitor includes a map 204, which displays a map of the area near the vehicle, which may include streets 210 and a pictorial indication 212 of any obstructions. The monitor 202 may also include a obstruction viewer 208 to provide a more detailed picture and/or an alphanumeric description of the obstruction 212.

In combination with the obstruction viewer 208 and/or the map 204, the navigation system 10 may employ an alarm 22. The alarm may be one or more of a variety of different alarms known in the art, such as visual or audio indicators. In the case of a visual indicator, a simple warning light may be used, which can be located, for example, on the dash board of the vehicle apart from the monitor 202 or as part of the monitor. Besides of a simple warning light, the visual indicator may be more complex. For example, FIG. 3 depicts a visual display of the vehicle's outline on the monitor 20. When a collision is predicted, a section of the vehicle's outline will light up where the probable impact will likely occur.

In the case of an audio indicator, a speaker may be used, which may be located on the dashboard apart or integrated into the monitor 202. Alternatively, the speakers may be placed throughout the vehicle and the speaker closest to the location of probable impact with the vehicle will sound if a collision is predicted. The sound of the speaker or speakers may change in volume or pitch depending on the likelihood of the collision.

Even though the visual and/or the audio indicators may communicate that a crash is predicted, the driver may not have the time, opportunity, or ability to make the proper correction. For this reason, the controller may optionally include an electronic control device 34, which is used to activate certain systems in the vehicle to decrease the likelihood of serious injury to the vehicle's occupants. These systems can include the braking system 24, the engine system 26, and/or a safety system 28 with one or more safety devices.

The controller 12 comprises the microprocessor 30, the memory 32, and the ECU 34. In an attempt to prevent a predicted collision, the microprocessor carries out the calculations in response to signals from the sensors. The memory 32 stores the programs to operate various engine or braking systems including suitable operational parameters for the vehicle for a variety of possible circumstances that can be predicted by the microprocessor 30.

The engine system 26 comprise a steering actuator 36 and a throttle actuator 38 while the braking system 24 comprise a brake actuator 40. If the microprocessor 30 determines that it is necessary to operate any of these actuators, it sends a signal to the ECU 34, which produces a steering gear ratio command, a set velocity command, and a brake operational command. The steering actuator 36, the throttle actuator 38 and the brake actuator 40 are operated in response to the steering gear ratio command, the set velocity command and the brake operational command, respectively.

The steering actuator 36 is a hydraulic actuator for use in rotating the steering wheel in an emergency. In this event, the steering wheel is automatically rotated according to the steering gear ratio and rotational direction indicated by the steering gear ratio command. The operational amount of the steering actuator can be controlled in a well-known manner through a servo valve and a hydraulic pump. The throttle actuator 38 acts to adjust the opening amount of a throttle valve to decrease speed while evading the obstructions. The brake actuator 40 performs a function to gradually decrease the speed of the vehicle in response to the brake operational command. The brake actuator 40 is also capable of achieving sudden brake operation, if necessary.

The ECU 34 may also be used to activate one or more safety devices to better protect the vehicle's occupants in case the predicted collision actually occurs. The ECU 34 may inflate an airbag 42, retract a MSB 44, or activate any other known safety device.

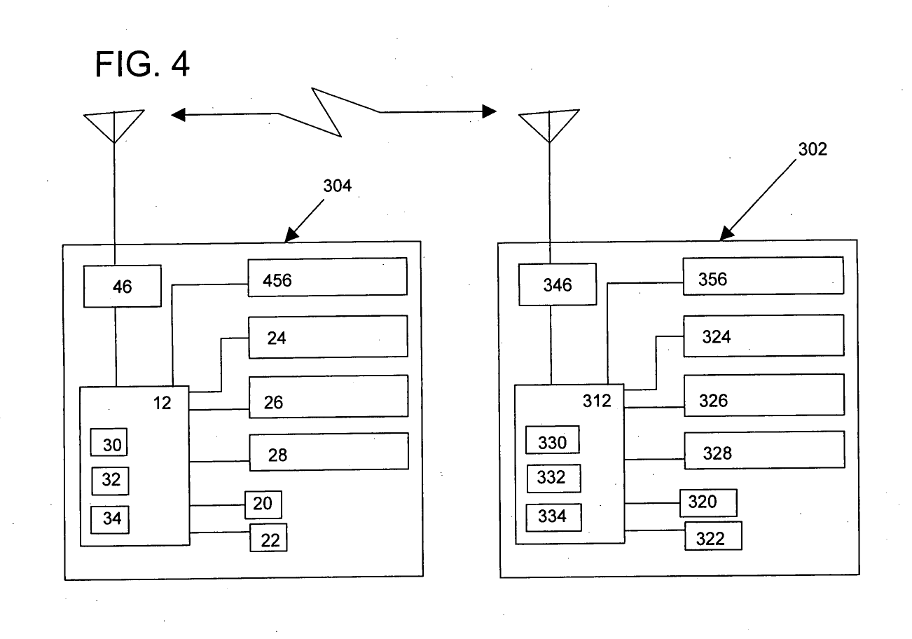

Referring back to FIG. 1, the navigation system is connected to a transmitter/receiver 46, which can relay to information to and from other vehicles about possible obstructions detected by the vehicle. The information received by the vehicle is used by the controller 12 in its determination of predicting crashes. FIG. 4 depicts a schematic of some of the various types of systems that can send information to the transmitter/receiver. Those reference numerals that are the same as seen in FIG. 1 indicate the same components as depicted in FIG. 1. Information about the first vehicle 302 is obtained from various systems and sent to the transmitter/receiver 346. The transmitter/receiver 346 transmits the information in a wireless fashion by any number of techniques, such as using radio waves or infrared transmission. The transmitter/receiver 46 in a second vehicle 304 receives the information transmitted by vehicle 302 and processes it in its controller 12. The second vehicle will then determine if a crash is predicted based on the transmitted information and/or its own sensors. If a crash is predicted, the second vehicle will engage the monitor 20, the alarm 22, the braking system 24, the engine system 26, and/or the safety system 28, as shown in FIG. 1.

The various systems of the vehicle 302 that can provide information will now be explained. These systems include the steering system 326, the braking system 324, the passenger safety system 328, the ABS system 356, and/or the controller 312. The information from the steering system 326 may indicate abrupt steering that may be due to an obstruction or the driver losing control of the vehicle.

The braking system 324 may indicate harsh braking by using a brake pedal velocity sensor of a known type. This sensor is typically mounted on or near the vehicle's brake pedal and functions to sense the rate of downward travel of the brake pedal during a braking sequence. The rate of pedal travel is compared against a reference value to determine whether the rate of travel indicates a panic-braking mode.

The safety system 328 may indicate the deployment of one or more airbags, the activation of one or more seat belt retractors, or the use of other passenger safety devices and systems known in the art.

The ABS system 356 may indicate the presence of slippery road conditions or that the first vehicle is slipping. The signal produced by the ABS system 356 may be either that signal which activates the system 356, or another system signal that is generated immediately upon activation of the system 356.

The controller 312 of the first vehicle 302 also sends information to the transmitter/receiver 346 relating whether a crash of the first vehicle is predicted by its controller 312. If such information is sent to the second vehicle, a chain crash could be avoided. For this reason, the first vehicle also includes sensors (not shown) connected to a controller 312, a microprocessor 330, a memory 332, an ECU 334 that controls the braking system 324, the engine system 326, and/or safety devices in the safety system 328, a monitor 320, and an alarm 322.

The information from the first vehicle 302 is received by the second vehicle's transmitter/receiver 46 and processed in its controller 12 using the controller's computer model. As previously mentioned above in relation to FIG. 1, the controller 12 processes the signals the car's sensors 14, 16, 18 by using a neural network, by comparing various parameters to thresholds, or by any other suitable computer model. The signals from the first car can be incorporated into this model as additional parameters to be evaluated.

It should be noted that both the first and second vehicles have the capabilities to transmit data to each other. For this reason, the second vehicle 304 also includes steering system 26, the braking system 24, the passenger safety system 28, and the ABS system 456. Further, the first and second vehicle can receive data from other vehicles with the same crash prediction and avoidance system.

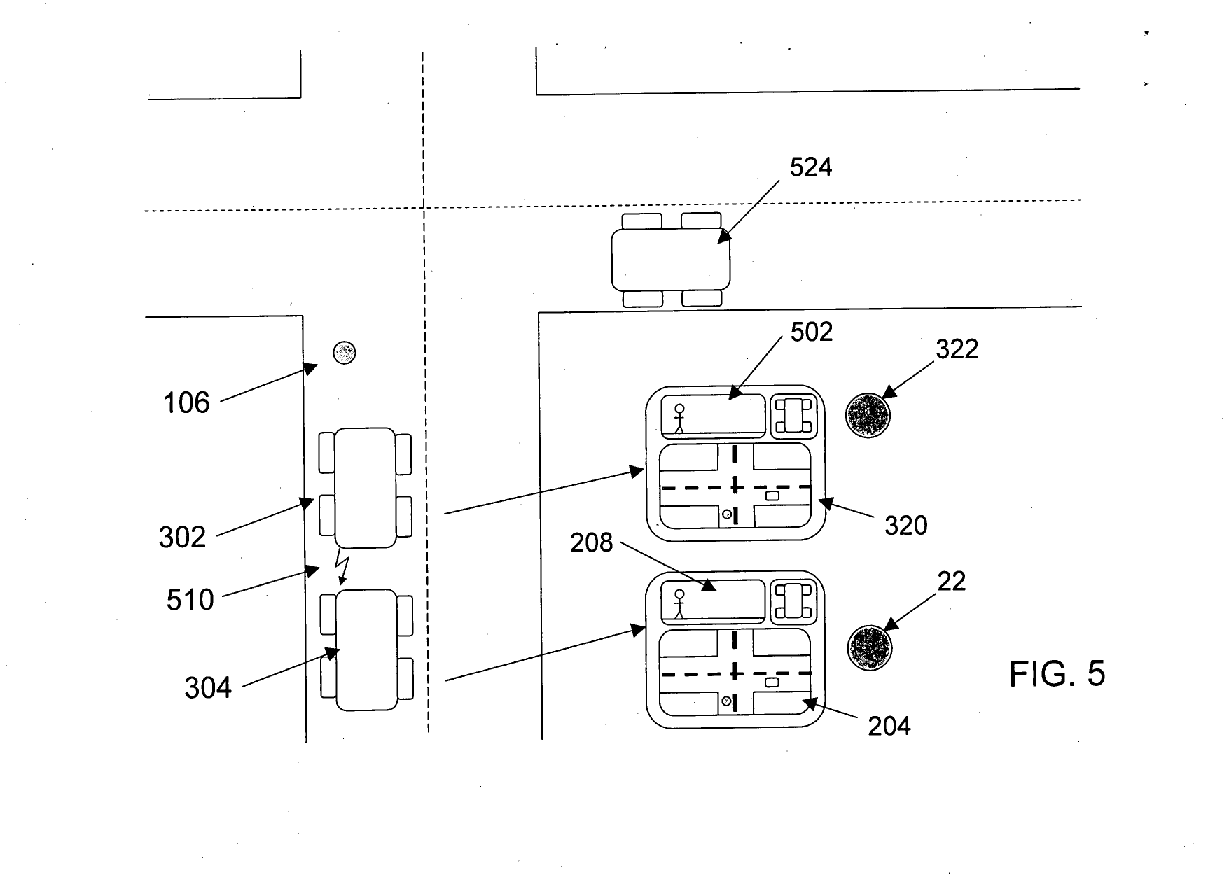

In addition to using data from the first vehicle in its determination of a possible crash, the second vehicle may also display the obstructions that the first vehicle has identified. FIG. 5 shows a first vehicle 302 being followed by a second vehicle 304. The first vehicle has identified an obstruction 106 in the form of a man crossing the street. This information is being displayed in the first vehicle's monitor 320 as well as alerting the driver by an audio alarm 322. The first vehicle's obstruction viewer 502 also provides a display of the obstruction.

The navigation system in second vehicle 304 may also display the obstruction 106 in front of a first vehicle 302 at its obstruction viewer 208 by using the information from the first vehicle 302. The second vehicle's navigation system map 204 shows the position of the obstruction 106, the first vehicle 302, and other vehicles in the vicinity, such as vehicle 524.

It should be understood that the present invention is not limited to the particular embodiments shown and described above, and various changed and modifications may be made without departing from the spirit and scope of the appended claims.

What is claimed is:

1. A vehicle system for avoiding collisions, comprising:
at least one sensor mounted on the vehicle that outputs at least one signal;
a receiver for receiving data from at least one other vehicle;
a controller that processes the received data and the at least one signal to determine if a crash is predicted; and
an alarm for issuing a warning if a crash is predicted.

2. The system of claim 1, wherein the controller activates at least one device in response to determining that a crash is predicted.

3. The system of claim 2, comprises a monitor for displaying obstructions.

4. The system of claim 1, wherein the at least one sensor collects and updates information regarding obstructions.

5. The system of claim 1, wherein the other vehicle is located in front of the vehicle.

6. A system for avoiding collisions in a vehicle, comprising:
at least one sensor mounted on the vehicle that outputs at least one signal;
a receiver for receiving data from at least one other vehicle;
a controller that processes the received data and at least one signal to determine if a crash is predicted; and
at least one device that is activated by the controller when a crash is predicted.

7. The system of claim 6, wherein the at least one device is the vehicle's engine.

8. The system of claim 6, wherein the at least one control device controls the braking system or a safety device.

9. A system for avoiding collisions in a vehicle, comprising:
at least one sensor mounted on the vehicle that outputs at least one signal;
a controller that processes the at least one signal to determine the location of any obstructions near the vehicle; and
a monitor for displaying the location of the vehicle and any obstructions near the vehicle.

10. The system of claim 9, wherein the controller also processes the at least one signal to determine if a crash is predicted.

11. The system of claim 9, wherein the controller triggers an alarm to indicate that a crash is predicted.
